(19) United States
(12) Patent Application Publication
(10) Pub. No.: US 2007/0085643 A1
(43) Pub. Date: Apr. 19, 2007

(54) Operating mechanism having a toggle rivet assembly and method of manufacture

(75) Inventor: Lance Gula, Clinton, PA (US)

Correspondence Address: MARTIN J. MORAN, ESQ.;Eaton Electrical, Inc., Technology & Quality Center, 170 Industry Drive, RIDC Park West, Pittsburgh, PA, 15275-1032, US

(73) Assignee: EATON CORPORATION

(21) Appl. No.: 11/445,550

(22) Filed: Jun. 2, 2006

Related U.S. Application Data
(63) Continuation-in-part of application No. 11/254,515, filed on Oct. 19, 2005.

(51) Int. Cl. H01H 9/00

(52) U.S. Cl. 335/172

(57) ABSTRACT

An operating mechanism for a circuit breaker includes a cradle having a generally planar body with a first link opening, at least one first link having an elongated body with a cradle opening, and a toggle rivet having a bushing component and a stake component. The bushing component has a hollow, generally cylindrical body with a first end and a second end, the first end having a radial flange extending outwardly. The stake component has an elongated body with a first end and a second end, the first end having a generally flat head and the second end having a distal tip. When assembled, the bushing component extends through the cradle body first link opening and the first link body cradle opening from a first direction, the stake component extends through the cradle body first link opening and the first link body cradle opening from a second direction, the stake component also extending through the hollow bushing component. In this configuration, the stake component distal tip is deformed thereby locking the bushing component and the stake component together.

### CROSS REFERENCE TO RELATED APPLICATION

This application is a continuation-in-part application that claims priority under 35 U.S.C. §119(e) to U.S. patent application Ser. No. 11/254,515, filed Oct. 19, 2005 entitled, CIRCUIT BREAKER INTERMEDIATE LATCH STOP.

### BACKGROUND OF THE INVENTION

### Field of the Invention

The present invention relates to circuit breakers and, more particularly, to a circuit breaker having a toggle rivet coupling the operating mechanism cradle to the supporting links.

### Background Information

Circuit breakers utilize an operating mechanism to move two conductive contacts between an open position and a closed position. The operating mechanism, typically, is disposed in non-conductive housings defining a limited enclosed space. Because the enclosed space is limited, especially in miniature circuit breakers and telecommunication circuit breakers, it is desirable to utilize components that are as small as possible. Such small components may, however, be difficult to assemble especially when the components are assembled within the enclosed space.

For example, two common operating mechanism components are a cradle and at least one link that is further coupled to a movable contact. Such an operating mechanism is disclosed in U.S. patent application Ser. No. 11/254,515, which is incorporated herein by reference. In such a circuit breaker, the cradle is manufactured with an opening. A pivot pin is fixed within the opening. The links, in this case two link, one link on each side of the cradle, have a yoke in which the pivot pin is disposed. One reason the yoke/pin combination is used is that the pin and the yoke may be structured with generally the same thickness. Thus, the overall width of the cradle and links may be minimized. However, because the yoke cannot trap the cradle pivot pin, it is possible for the links to disengage the cradle during assembly.

There is, therefore a need for an operating mechanism having a toggle rivet structured to couple at least one operating mechanism link to a cradle that pivotally locks the link and cradle together.

There is a further need for toggle rivet wherein the exposed portions of the toggle rivet have a limited thickness.

There is a further need for a method of manufacturing an operating mechanism having a toggle rivet.

### SUMMARY OF THE INVENTION

These needs, and others, are met by at least one embodiment of the disclosed invention which provides an operating mechanism having a toggle rivet. The toggle rivet includes two initially separate components, a bushing component and a spike component. The bushing component has a hollow body with an outwardly extending flange. The spike component has a head and an elongated body with a deformable distal tip. The spike body is sized to fit within the hollow bushing body. The bushing component flange and the spike component head have a limited thickness. The cradle and the at least one link are provided with generally circular openings, that is, not yokes. The openings are smaller than the bushing component flange and the spike component head, but larger than the body of the bushing component.

During assembly, the bushing component is inserted through the link opening and the cradle opening from a first direction. The spike component is inserted into the hollow bushing, and therefore through the link opening and the cradle opening, from a second direction. The distal tip of the spike component is then deformed, thereby locking the toggle rivet components together and rotatably coupling the at least one link and the cradle.

### BRIEF DESCRIPTION OF THE DRAWINGS

A full understanding of the invention can be gained from the following description of the preferred embodiments when read in conjunction with the accompanying drawings in which:

FIG. 1 is a side view of a circuit breaker a housing half shell removed.

FIG. 2 is a partially exploded view of the operating mechanism of FIG. 1.

FIG. 3 is a detailed end view of a circuit breaker operating mechanism.

FIG. 4 is an exploded view of the cradle, first links, and toggle rivet.

FIG. 5 is an isometric view of the cradle, first links, and toggle rivet during assembly.

FIG. 6 is an isometric view of the cradle, first links, and toggle rivet after assembly.

### DESCRIPTION OF THE PREFERRED EMBODIMENTS

The present invention is disclosed in association with a telecommunication system circuit breaker 10, such as the circuit breaker disclosed in U.S. patent application Ser. No. 11/254,515. However, the invention is also applicable to a wide range of circuit breakers for a wide range of applications such as, but not limited to, residential or molded case circuit breakers.

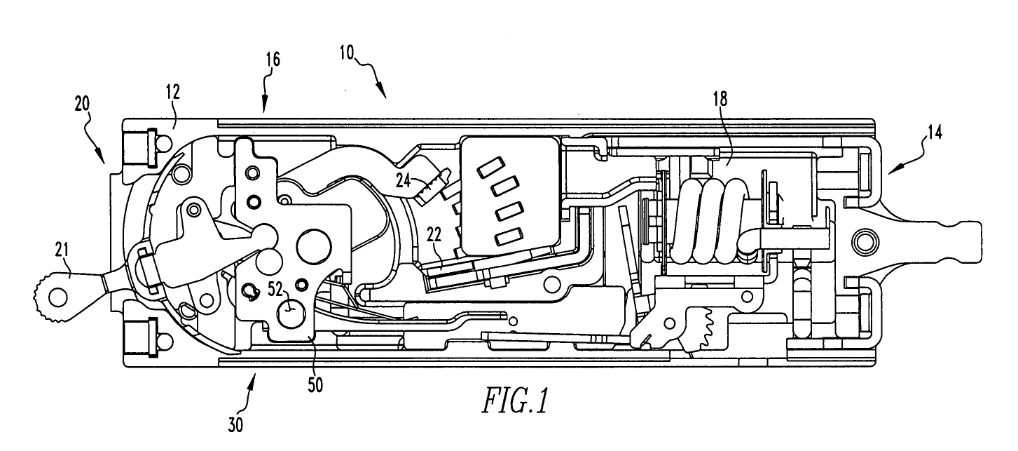

As shown in FIG. 1, and as is known in the art, a circuit breaker 10 includes a housing assembly 12, a current path assembly 14, an operating mechanism 16, a trip device 18, and a handle assembly 20. Generally, the current path assembly 14 includes a pair of separable contacts 22, 24 including a first, fixed contact 22 and a second, movable contact 24. The movable contact 24 is structured to be moved by the operating mechanism 16 between a first, closed position, wherein the contacts 22, 24 are in electrical communication, and a second, open position, wherein the contacts 22, 24 are separated, thereby preventing electrical communication therebetween. The trip device 1 8 is structured to detect an over current condition in the current path assembly 14 and to actuate the operating mechanism 16 to move the contacts 22, 24 from the first, closed position to the second, open position. The handle assembly 20 includes a handle member 21 which protrudes from the housing assembly 20. The handle assembly 20 further interfaces with the operating mechanism 16 and allows a user to manually actuate the operating mechanism 16 and move the operating mechanism 16 between an on position, an off position, and a reset position. As is known in the art, the housing assembly 12 may have support posts, pivot pin openings, pockets, and other support structures molded thereon which are structured to support or mount the various other components, such as the operating mechanism 16, within the housing assembly 12. Accordingly, as used herein, when a component is said to be coupled to the housing assembly 12, it is understood that the housing assembly 12 includes an appropriate support post, pivot pin opening, pocket, or other support structure(s) needed to engage the component.

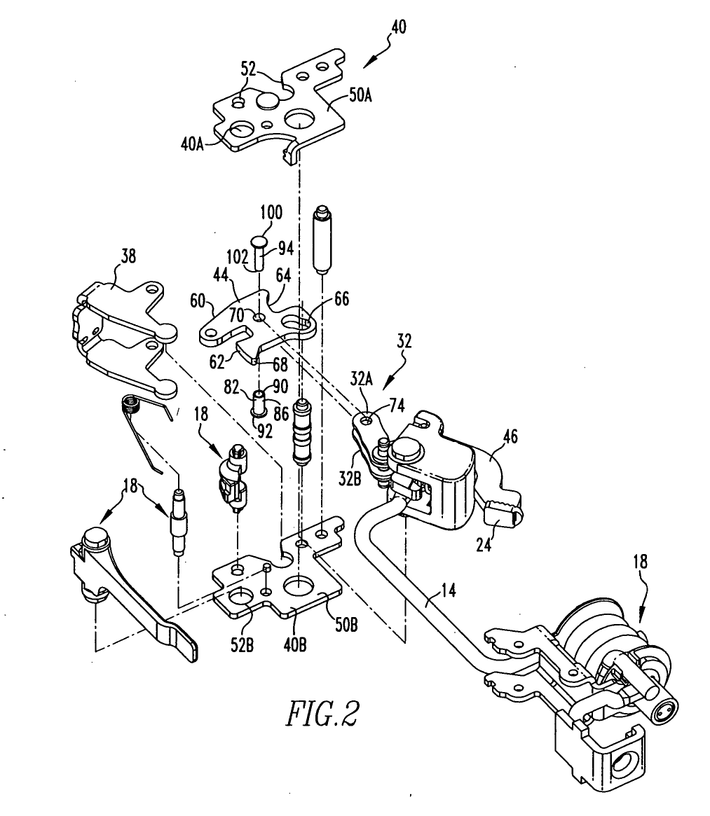

The operating mechanism 16 includes a plurality of rigid members 30 structured to be movable between four configurations or positions: a closed position, which is the normal operating position; a tripped position, which occurs after an over-current condition; an open position, which occurs after a user manually actuates the circuit breaker 10; and a reset position, which repositions certain members 30, described below, so that the contacts 22, 24 may be closed. In the preferred embodiment, the rigid members 30 are disposed in a generally layered/mirrored configuration. That is, whereas certain members 30 in the central layer are singular elements, other members 30 in the outer layers include two separate elements disposed on either side of the central elements. As set forth below, each member 30 will have a single reference number, however, when necessary to describe a member 30 that is split into two or more elements, e.g., right side and left side, that member's 30 reference number will be followed by either the letter “A” or the letter “B,” wherein each letter differentiates between the two separate elements. For example, the operating mechanism 16 includes at least one first link 32, but preferably includes two first links 32, a right side first link 32A and a left side first link 32B (FIG. 2). However, when shown in the Figures as predominantly a side view, FIG. 5, only a single first link 32 is visible and is identified. The same is true for elements such as, but not limited to, the primary spring 34 and the second link 36 (described below). Similarly, another member 30, such as handle arm 38 (described below) may be said to be coupled to the side plate 40 (described below) and it is understood that, unless otherwise specified, the handle arm 38 is coupled to both side plates 40A, 40B located on either side of the cage 42.

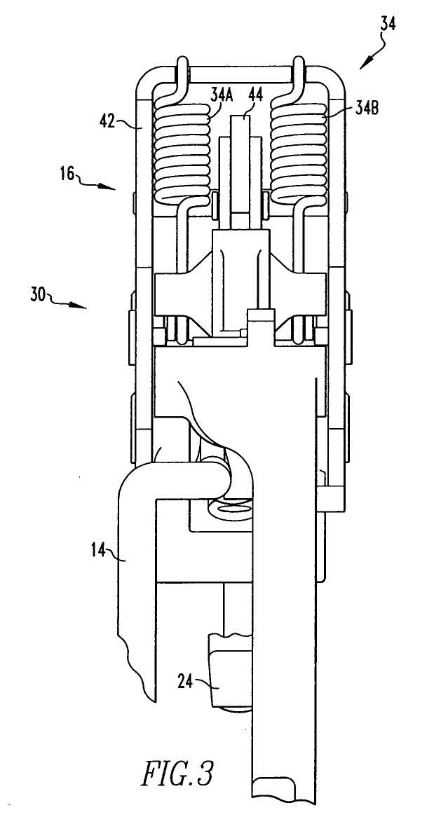

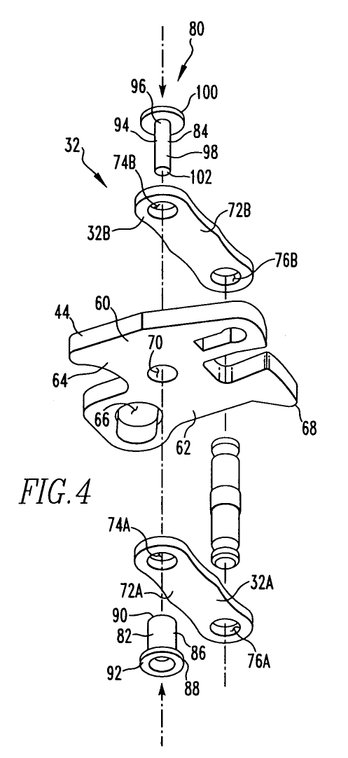

As shown best in FIGS. 2 and 3, the operating mechanism 16 includes the cage 42, that is structured to be coupled to the housing assembly 12, a cradle 44, the first link 32, the second link 36, a moving arm carrier 46, and a handle arm 38. The operating mechanism 16 also includes a plurality of springs 48, FIG. 3, including at least one primary spring 34. Preferably, there are two primary springs 34A, 34B, with one primary spring 34A, 34B disposed on each side of the cradle 44. The operating mechanism side plate 40 includes a body 50 having a plurality of openings 52. The openings 52 are structured to allow the operating mechanism 16 components to be coupled thereto as set forth in U.S. Pat. application Ser. No. 11/254,515 Unlike U.S. Pat. application Ser. No. 11/254,515, wherein the cradle 44 has a pivot pin opening and a pivot pin extending therethrough to which each first link 32 is coupled, each first link 32 is preferably coupled to the cradle 44 by a toggle rivet 80 as described below. That is, as shown in FIG. 4, the cradle 44 has a generally planar body 60 having an elongated base portion 62 with a generally perpendicular extension 64. The base portion 62 includes, adjacent to one end, a pivot pin opening 66 and, on the end opposite the pivot pin opening 66, a latch edge 68. The base portion 62 also includes a first link opening 70. The first link 32 has a generally elongated body 72 having a cradle opening 74 and a second link opening 76 at opposing ends.

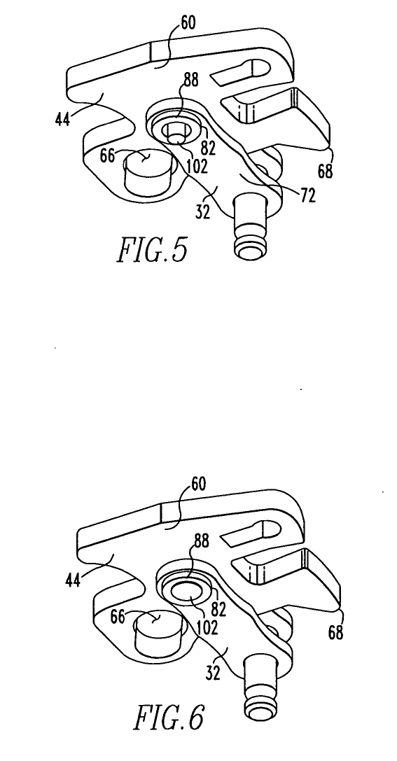

The toggle rivet 80 has a bushing component 82 and a stake component 84. The bushing component 82 includes a hollow, generally cylindrical body 86 with a first end 88 and a second end 90. The bushing body first end 88 has a radial flange 92 extending outwardly. The bushing body radial flange 92 has a sufficiently large diameter so that the bushing body radial flange 92 cannot pass through the first link body cradle opening 74. The radial flange 92 has a thickness of between about 0.018 and 0.022 inch, and more preferably about 0.020 inch. The bushing component 82 may be heat treated to improve the wear and strength capabilities thereof. The stake component 84 has an elongated body 94 with a first end 96 and a second end 98. The stake component body first end 96 has a generally flat head 100. The stake body second end 98 has a distal tip 102. The stake body flat head 100 has a thickness of between about 0.018 and 0.022 inch, and more preferably about 0.020 inch. The bushing body first end 88 and second end 90 are both open ends. The stake component body 94 is sized to fit, preferably snuggly, within the bushing body 86. The stake component body distal tip 102 is structured to deform when a compressive force is applied thereto. The bushing component body 86 is structured to not deform when a compressive force is applied thereto. Preferably, the bushing body first end 88 is sufficiently wide so that, following deformation of the stake component body distal tip 102, the stake component body distal tip 102 is countersunk within the bushing body first end 88 (FIG. 6). Prior to deformation, as shown in FIG. 5 and described below, when the stake component body 94 is inserted through the bushing component body 86, the stake component body 94 has a sufficient length so that the stake component body distal tip 102 extends slightly beyond the bushing component flange 92.

The at least one first link 32 is rotatably coupled to the cradle 44 by inserting the bushing component 82 through the cradle body first link opening 70 and the first link body cradle opening 74 from a first direction. The stake component 84 is then inserted through the hollow bushing component second end 90 in to the bushing component 82 as well as through the cradle body first link opening 70 and the first link body cradle opening 74 from a second direction. Where there are two first links 32A, 32B, the bushing component 82 is inserted through the right side first link body cradle opening 74A, the cradle body first link opening 70 and the left side first link body cradle opening 74B from a first direction. Then, the stake component 84 is inserted, via the hollow bushing component second end 90, through the left side first link body cradle opening 74B, the cradle body first link opening 70 and the right side first link body cradle opening 74A from a second direction.

In this configuration, the stake component body flat head 100 abuts the bushing body second end 90 and the stake component body distal tip 102 extends slightly beyond the bushing component flange 92. As shown in FIG. 6, at this point the stake component distal tip 102 is deformed by compressing the toggle rivet 80 thereby locking the bushing component 82 and the stake component 84 together. Because the stake component body flat head 100 abuts the bushing body second end 90 and because the bushing body 86 does not deform, compression of the toggle rivet 80 does not shorten the length of the toggle rivet 80. Thus, after compression, the toggle rivet 80 does not compress the at least one first link 32 and the cradle 44 and therefore the at least one first link 32 is rotatably coupled to the cradle 44. Moreover, because the bushing body radial flange 92 and the stake body flat head 100 have a limited thickness, the toggle rivet 80 does not intrude upon the space occupied by the two primary springs 34A, 34B.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. An operating mechanism for a circuit breaker comprising:
a cradle having a generally planar body with a link opening;
at least one first link having an elongated body with a cradle opening;
a toggle rivet having a bushing component and a stake component;
said bushing component having a hollow, generally cylindrical body with a first end and a second end, said first end having a radial flange extending outwardly;
said stake component having an elongated body with a first end and a second end, said first end having a generally flat head and said second end having a distal tip;
wherein said bushing component extends through said cradle body first link opening and said first link body cradle opening from a first direction, said stake component extends through said cradle body first link opening and said first link body cradle opening from a second direction, said stake component also extending through said hollow bushing component; and
wherein said stake component distal tip is deformed thereby locking said bushing component and said stake component together.

2. The operating mechanism for a circuit breaker of claim 1, wherein said bushing component flange has a thickness of between about 0.018 and 0.022 inch.

3. The operating mechanism for a circuit breaker of claim 2, wherein said bushing component flange has a thickness of about 0.020 inch.

4. The operating mechanism for a circuit breaker of claim 1, wherein said stake component head has a thickness of between about .018 and .022 inch.

5. The operating mechanism for a circuit breaker of claim 2, wherein said stake component head has a thickness of about .020 inch.

6. The operating mechanism for a circuit breaker of claim 1, wherein said stake component distal tip, following deformation, does not extend beyond said bushing component flange.

7. The operating mechanism for a circuit breaker of claim 1, wherein, following deformation of said stake component distal tip, said toggle rivet does not compress said at least one first link and said cradle, whereby said at least one first link is rotatably coupled to said cradle.

8. The operating mechanism for a circuit breaker of claim 1, wherein:
said at least one first link includes two first links, a right side first link and a left side first link, each first link having an elongated body with a cradle opening; and
wherein said bushing component extends through said right side first link body cradle opening, said cradle body first link opening and said left side first link body cradle opening from a first direction, said stake component extends through said left side first link body cradle opening, said cradle body first link opening and said right side first link body cradle opening from a second direction.

9. The operating mechanism for a circuit breaker of claim 8, wherein, following deformation of said stake component distal tip, said toggle rivet does not compress said right side first link, said cradle, and said left side first link, whereby said right side first link and said left side first link are rotatably coupled to said cradle.

10. A method of assembling an operating mechanism for a circuit breaker, said circuit breaker having a housing assembly, said operating mechanism having a cage structured to be coupled to said housing assembly, a cradle having a generally planar body with a first link opening, at least one first link having an elongated body with a cradle opening, and a toggle rivet having a bushing component and a stake component, said bushing component having a hollow, generally cylindrical body with a first end and a second end, said first end having a radial flange extending outwardly, said stake component having an elongated body with a first end and a second end, said first end having a generally flat head and said second end having a distal tip, said method comprising:
a) inserting said bushing component through said cradle body first link opening and said first link body cradle opening from a first direction;
b) inserting said stake component through said cradle body first link opening and said first link body cradle opening from a second direction, said stake component also being inserted through said hollow bushing component; and
c) deforming said stake component distal tip thereby locking said bushing component and said stake component together.

11. The method of claim 11 wherein said step of deforming said stake component distal tip includes the step of flattening said distal tip so that said distal tip does not extend beyond said bushing component flange.

12. The method of claim 11 wherein during said step of deforming said stake component distal tip, said toggle rivet does not compress said at least one first link and said cradle, whereby said at least one first link is rotatably coupled to said cradle.

13. The method of claim 11 wherein said at least one first link includes two first links, a right side first link and a left side first link, each first link having an elongated body with a cradle opening and said steps of inserting said bushing component and inserting said stake component includes the steps of:
a) inserting said bushing component through said right side first link body cradle opening, said cradle body first link opening and said left side first link body cradle opening from a first direction; and
b) inserting said stake component through said left side first link body cradle opening, said cradle body first link opening and said right side first link body cradle opening from a second direction.

14. The method of claim 13 wherein during said step of deforming said stake component distal tip, said toggle rivet does not compress said right side first link, said cradle, and said left side first link whereby said right side first link and said left side first link are rotatably coupled to said cradle.

15. The method of claim 11 further comprising the steps of:
a) coupling said cradle member to said cage; and
b) coupling said cage to said housing assembly.

16. A toggle rivet for a circuit breaker operating mechanism, said operating mechanism having a cradle with a generally planar body with a first link opening therein, and at least one first link having an elongated body with a cradle opening, said interlocking toggle rivet assembly comprising:
a bushing component and a stake component;
said bushing component having a hollow, generally cylindrical body with a first end and a second end, said first end having a radial flange extending outwardly;
said stake component having an elongated body with a first end and a second end, said first end having a generally flat head and said second end having a distal tip;
wherein said bushing component extends through said cradle body first link opening and said first link body cradle opening from a first direction, said stake component extends through said cradle body first link opening and said first link body cradle opening from a second direction, said stake component also extending through said hollow bushing component; and
wherein said stake component distal tip is deformed thereby locking said bushing component and said stake component together.

17. The toggle rivet of claim 16, wherein, following deformation of said stake component distal tip, said toggle rivet does not compress said at least one first link and said cradle, whereby said at least one first link is rotatably coupled to said cradle.

18. The toggle rivet of claim 16, wherein:
said at least one first link includes two first links, a right side first link and a left side first link, each first link having an elongated body with a cradle opening; and
wherein said bushing component extends through said right side first link body cradle opening, said cradle body first link opening and said left side first link body cradle opening from a first direction, said stake component extends through said left side first body cradle opening, said cradle body first link opening and said right side first link body cradle opening from a second direction.

19. The toggle rivet of claim 18, wherein, following deformation of said stake component distal tip, said toggle rivet does not compress said right side first link, said cradle, and said left side first link, whereby said right side first link and said left said first link are rotatably coupled to said cradle.

20. The toggle rivet of claim 16, wherein:
said bushing component flange has a thickness of between about 0.018 and 0.022 inch; and
said stake component head has a thickness of between about 0.018 and 0.022 inch.
